(19) United States
(12) Patent Application Publication
(10) Pub. No.: US 2018/0067502 A1
(43) Pub. Date: Mar. 8, 2018

(54) DRONE SECURITY SYSTEM

(71) Applicant: RICHARD CHI-HSUEH, SAN DIEGO, CA (US)

(72) Inventor: RICHARD CHI-HSUEH, SAN DIEGO, CA (US)

(21) Appl. No.: 15/670,166

(22) Filed: Aug. 7, 2017

Related U.S. Application Data
(60) Provisional application No. 62/372,818, filed on Aug. 10, 2016.

(51) Int. Cl. G05D 1/10; G07C 5/00; G08B 13/196; B64D 47/08; B64C 39/02

(52) U.S. Cl. CPC G05D 1/101; G07C 5/008; G08B 13/19621; B64D 47/08; B64C 2201/145; G08B 13/1965; B64C 2201/146; B64C 2201/127; B64C 39/024

(57) ABSTRACT

A drone security system is revealed. The system includes a plurality of positioning units, a mainframe, at least one drone base, and a mobile device. Each positioning unit consists of a positioning sensing module and a signal transmitting module. The mainframe is wirelessly connected to the positioning units and is formed by a processor, a signal receiving module, a central data center and an information display module. The drone base is in electrical connection with the mainframe and each drone base includes at least one drone that is disposed with a deterrent device. The mobile device is in electrical connection with the mainframe and the at least one drone base. Thereby safety guards required can be replaced by drones that reach intrusion area quickly and synchronously so that security of the area is ensured.

### FIELD OF THE INVENTION

The present invention relates to at least one motion sensored security drone applied to a security system for preventing intrusion of a person, an animal or movable machine into a certain area (such as farm, forest, fishing ground, ranch, factory area, a courtyard house, a mall, a school, a river, a stream, a harbor, a coast, etc). The tracking and positioning of an intruding object/intruder and activation of the drone for tracking can be achieved by techniques related to Internet of things (IoT) and mobile device apps. A deterrent device on the drone can be used to deter or drive the intruders away and the app that runs on the mobile device can monitor tracking and deterring actions of the drone in the real time manner.

### SUMMARY OF THE INVENTION

At least one motion sensored security drone applied to a security system according to the present invention can be used within a certain area (such as farm, forest, fishing ground, ranch, factory area, a courtyard house, a mall, a school, a river, a stream, a harbor, a coast, etc). A plurality of positioning units is disposed within the area. When a positioning sensing module built in one of the positioning units in the area detects an intruder such as a person, an animal or a movable machine, a wireless transmitting module built in the positioning unit immediately sends a signal to a mainframe to be shown on an information display module of the mainframe. Then the mainframe sends a signal related to geographic location of the intruder to a mobile device and an activating signal to the drone for starting a motor of the done. Thus the drone flies to an intrusion location right away. A charge-coupled device (CCD) is turned on for one-to-one monitoring once the drone reaches the intrusion location. If there is a plurality of intruders, a plurality of drones is activated to monitor each intruder respectively according to a plurality of intrusion locations detected by different positioning sensing modules. At the same time, the images or videos of the intruder monitored and captured by the CCD on the drone are transmitted to the mainframe and the mobile device synchronously for storage. Then the processor of the mainframe or the APP interface on the mobile device determines whether a deterrent action is taken. Once it is confirmed that the deterrent action is taken, a device arranged at the drone such as a strong light beam, an ultrasonic frequency, or an audio frequency is turned on by manual operation, automatic computer control of the mainframe, or manual operation of the mobile device to deter or drive the intruder away. The strong light beam is aimed onto the intruder while the ultrasonic frequency and the audio frequency are used for interfering and deterring respectively. The present invention uses the drone to monitor and deter the intruder. The security staff originally required can be replaced by the drone that can reach the intrusion location for evidence collection. Moreover, the drone also prevents possible injury to the security guards when the security guard is checking the intrusion location, facing or deterring the intruder.

### BRIEF DESCRIPTION OF THE DRAWINGS

FIG. 1 is a schematic drawing showing farm, forest, fishing ground and ranch of an embodiment according to the present invention;

FIG. 2 is a schematic drawing showing factory area or a courtyard house of an embodiment according to the present invention;

FIG. 3 is a schematic drawing showing disposition of drones of an embodiment according to the present invention;

FIG. 4 is a schematic drawing an embodiment in use according to the present invention;

FIG. 5 is a system block diagram of an embodiment according to the present invention.

### REFERENCE NUMBERS OF THE ELEMENTS

1 farm, forest, fishing ground and ranch
2 factory area and a courtyard house
01 motion sensored security drone
001 positioning unit
011 intrusion sensor
012 signal transmitting module
005 mainframe
051 processor
052 signal receiving module
053 information display module
054 central data center
002 drone
021 CCD camera
022 strong light beam
023 ultrasonic frequency
024 high audio frequency
025 net ejector
026 voice amplifier microphone
027 infrared (IR) temperature sensor
003 mobile device
004 wireless charger module

### DETAILED DESCRIPTION OF THE PREFERRED EMBODIMENT

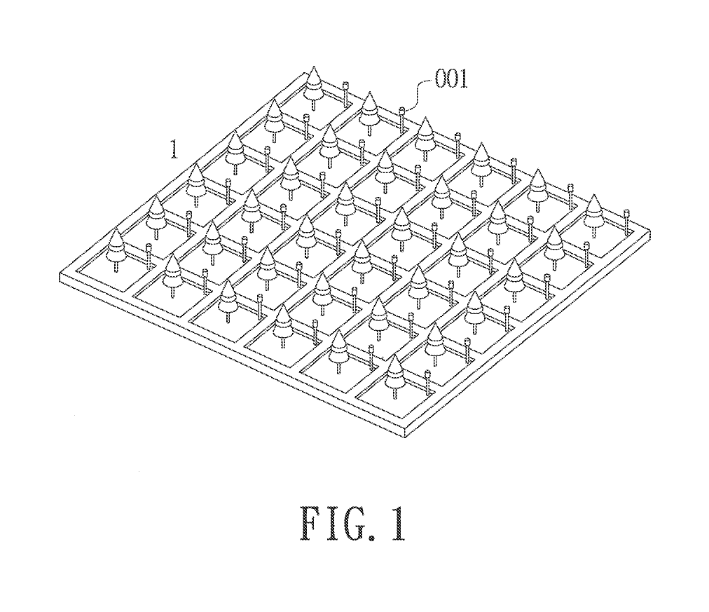

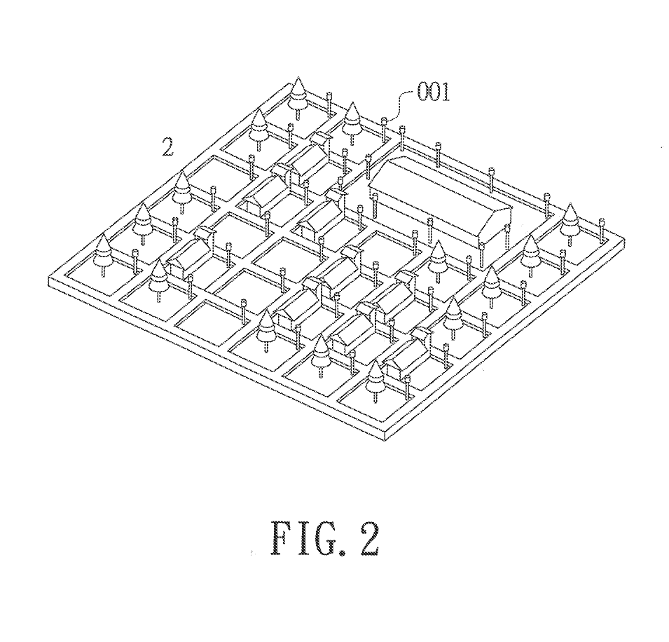

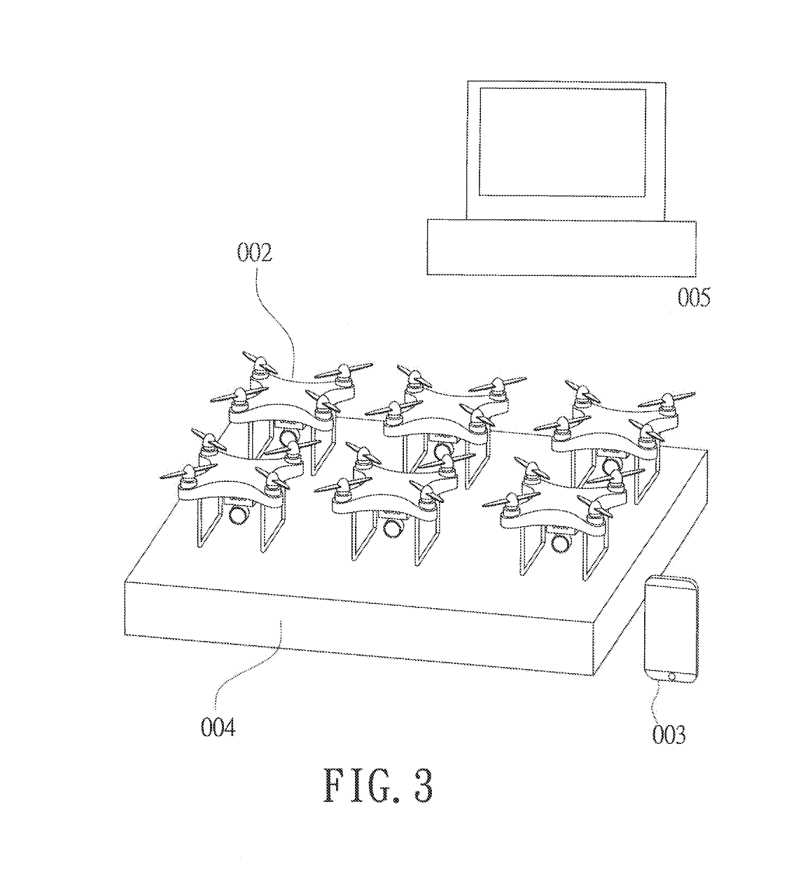

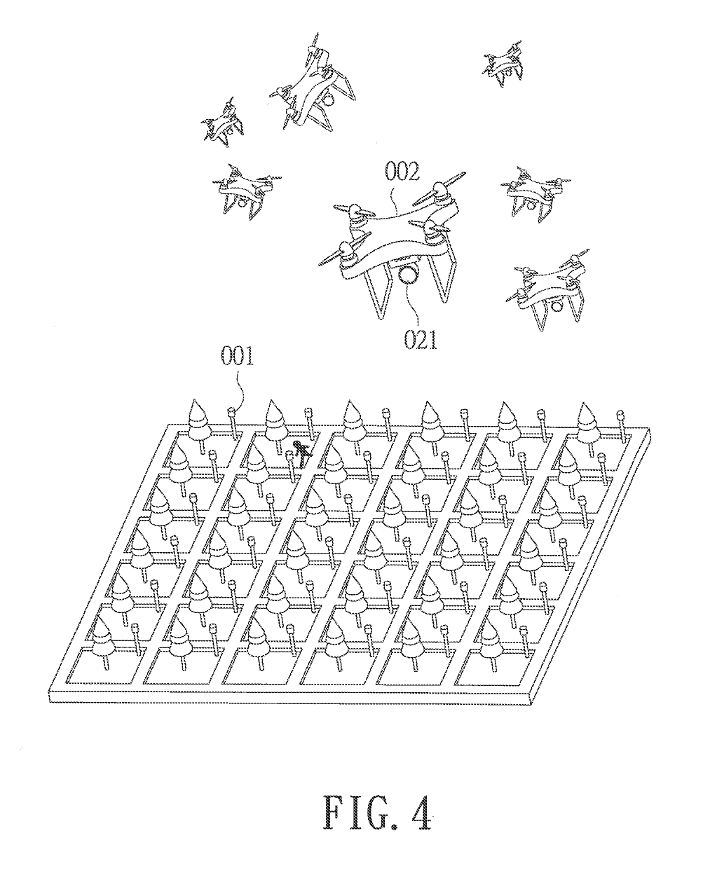

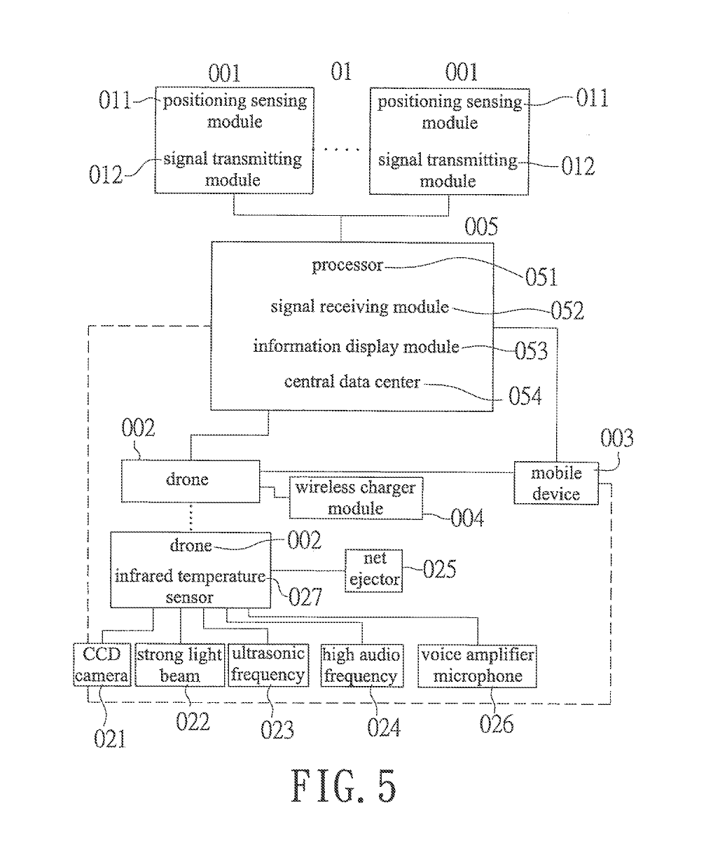

1. As shown in FIG. 1 and FIG. 2, an embodiment of the present invention is used in farm, forest, fishing ground and ranch 1 or factory area and a courtyard house 2. A motion sensored security drone 01 of the present invention includes a plurality of positioning units 001 built in a specific area such as farm, forest, fishing ground, ranch, factory area or a courtyard house. The positioning unit 001 is arranged at each section of the area 1 or the area 2.
2. The present motion sensored security drone includes a plurality of positioning units 001 of the embodiment shown in FIG. 1, at least one drone 002 of the embodiment shown in FIG. 3, a mainframe 005, a mobile device 003 and a wireless charger module 004 used for providing power to the drone.
3. The positioning of coordinates of the positioning unit 001 can be achieved by the conventional map information system such as google map, baidu map, etc. First the relative geographic coordinates of each positioning unit 001 are confirmed and labeled and then to be stored in a central data center 054 of the mainframe.
4. As the system block diagram of an embodiment of the present invention shown in FIG. 5, the positioning unit 001 can be built with a GPS (global positioning system) module and an intrusion sensor 011. The GPS module is for checking the geographic coordinates of each positioning unit 001 while the intrusion sensor 011 detects an intrusion and sends an intruding signal as well as GPS coordinates of the positioning unit to a signal receiving module 052 in the mainframe 005 through a signal transmitting module 012 in the positioning unit 001 when there is an intruder in the area 1 or the area 2.
5. As shown in FIG. 5, the intruding signal and the GPS coordinates received by the signal receiving module 052 are shown on an information display module 053 of the mainframe in the real time manner. At the same time, the GPS geographic coordinates of the positioning unit being intruded is determined by the map information system originally stored in the central data center 054 and the GPS module built in the positioning unit 001. After confirming the GPS coordinates of the intrusion location, the mainframe 005 sends an intrusion signal to both the mobile device 003 and the information display module 053 of the mainframe.
6. Refer to FIG. 5, staff such as security guards can carry out protection actions such as monitoring and deterring quickly and manually by using a command line interface on the information display module 053 of the mainframe or the mobile device 003 application (APP) with a command line interface. Or the protective measures are executed automatically by commands for monitoring, deterring or catching purposes preset in a processor 051 of the mainframe or the mobile device 003 APP.
7. Refer to the embodiment in use shown in FIG. 4 and the system block diagram shown in FIG. 5, the processor 051 of the mainframe 005 immediately activates the drone 002 to move to the GPS coordinates of the intrusion location for taking monitoring or deterrent action according to the commands for protection measures preset therein. The GPS coordinates of the intrusion location is confirmed by the processor 051. The drone activates a CCD 021 right away for taking pictures and one-to-one monitoring of the intruder. If there is a plurality of intruders, a plurality of drones is activated to monitor each intruder respectively according to a plurality of intrusion locations detected by different intrusion sensors 011. At the same time, the images or videos of the intruder monitored and captured by the CCD 021 on the drone are transmitted to the mainframe 005 and the mobile device 003 synchronously for recording and storage. The CCD 021 can be an infrared night-vision camera that works well at night.
8. Refer to FIG. 5, the CCD 021 activated also transmits the images captured to the processor 051 of the mainframe 005 synchronously. Thus the processor 051 analyzes data of the intruder to confirm that the intruder is a person, an animal or a movable machine. Then the processor 051 of the mainframe or the APP interface on the mobile device 003 determines whether a deterrent action is taken. Once it is confirmed that the deterrent action is taken, a device arranged at the drone such as a strong light beam 022, an ultrasonic frequency 023, a high audio frequency 024, or a voice amplifier microphone 026 is turned on by manual operation of the mainframe, automatic computer control of the mainframe, or manual operation of the mobile device to warn or drive the intruder 5.away. The strong light beam 022 is aimed onto the intruder while the ultrasonic frequency 023 and the high audio frequency 024 are used for interfering and deterring respectively. The voice amplifier microphone 026 can be used to warn and talk to the intruder. Or a net ejector 025 equipped on the drone is activated to catch the intruder.
9. As shown in FIG. 5, the manual operation is through the command line interface on the information display module 053 of the mainframe or the mobile device 003 APP with the command line interface. Thus the drone 002 is activated and moved to the intrusion location for monitoring, deterring and taking pictures of the intruder. The GPS coordinates of the intrusion location are confirmed by the processor 051. This drone 002 is arranged with an infrared (IR) temperature sensor 027 for finding out what the intruder is according to the temperature measured and sending temperature data to the mainframe wirelessly. Humans and animals have different body temperature. The processor 051 in the mainframe sends a command to the drone 002 for locking the intruder out according to the temperature data and keeping monitoring and deterring the intruder.
10. The present invention builds a security system based on Zigbee wireless personal area network built on IEEE 802.15.4 that is a technical standard defined by Institute of Electrical and Electronics Engineers (IEEE). Zigbee protocol layer can be divided into physical layer (PHY), media access layer (MAC), network layer (NWK), application layer (APL), etc. Zigbee operates in the three radio bands: 2.4 GHz (worldwide), 868 MHz (Europe) and 915 MHz (USA). There are three kinds of devices in the network layer including Zigbee coordinator, Zigbee router and Zigbee end device. Zigbee is a Wireless Personal Area Network (WPAN) that uses IEEE 802.15.4 MAC and PHY for the lower layers. A powerful wireless sensor network can be set up based on Zigbee. 2.4 GHz or 5.8 GHz wireless technology with remote control function that meets transmission requirements of the present invention.
11. The wireless sensor network of the present motion sensored security drone can also be set up based on other communication protocols such as Bluetooth, Z-Wave, Wi-Fi, EnOcean, Power Line Communication (PLC), etc. Communication modes such as Point-to-Point, Point-to-Multipoint configurations, multi-master mode, Time division multiple access (TDMA) mode, Frequency Hopping Spread Spectrum (FHSS) used in a repeater mode in the 902-928 MHz ISM band can also be used.
12. As shown in FIG. 3, the present motion sensored security drone 01 is equipped with a wireless charger module 004 for supplying power to at least one drone 002 in a wireless way at all times. Yet the charge mode of the drone 002 is not limited to the above way. The mainframe 005 and the mobile device 003 of the present system are in wireless connection with the drone 002 and ready to work at any time.
13. The present invention combines at least one drone 002 with the mobile device 003. The mobile device can be a mobile station, an advanced mobile station (AMS), a wireless terminal/communication device, a mobile phone, a smartphone, a tablet personal computer or an analogue.
14. The present invention uses the drone flying stably and able to take videos in the air after being equipped with the tripod/ball head and the camera. The videos are transmitted to the mobile device 003 or the mainframe 005 on the ground by wireless communication (such as 5.8 GHz, Wi-Fi or LTE (Long Term Evolution)) in the real time manner.
15. Refer to the system block diagram shown in FIG. 5, the central data center 054 is a storage unit such as memory, hard disk or other data storage component for recording a plurality of codes or modules.
16. As shown in the system block diagram of FIG. 5, the processor 051 is connected to the signal receiving module 052, the information display module 053 and the central data center 054. The processor 051 can be a general-purpose processor, a special-purpose processor, a conventional processor, a digital signal processor, a programmable microprocessor, a central processing unit (CPU), a digital signal processor (DSP), a controller, a microcontroller, an application specific integrated circuit (ASIC), a Field Programmable Gate Array (FPGA), other type of integrated circuit, a finite-state machine, an Advanced RISC machine (ARM) processor, an ARM chipset, or an analogue.
17. Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. A motion sensored security drone applied to a security system is built in a certain area (such as farm, forest, fishing ground, ranch, factory area, a courtyard house, a mall, a school, a river, a stream, a harbor, a coast, etc); the system immediately checks and shows geographic location and coordinates of an intrusion area and then activates at least one drone to track and deter an intruder when the intruder enters the intrusion area.

2. A motion sensored security drone applied to a security system comprising a plurality of positioning units, at least one drone, a mainframe, a mobile device and a wireless charger module for providing power to the drone;
wherein the positioning units are built in a specific area and each of the positioning units is arranged at each section of the specific area; positioning of coordinates of the positioning unit is achieved by a conventional map information system; first relative geographic coordinates of each of the positioning units are confirmed and labeled and then stored in a central data center of the mainframe; wherein the positioning unit is built with a GPS (global positioning system) module used for checking the geographic coordinates of each of the positioning units and then an intrusion location is sent to both the mainframe and the mobile device by a signal transmitting module in the positioning unit;
wherein the positioning unit is disposed with an intrusion sensor electrically connected to a microprocessor, the intrusion sensor sends an intruding signal as well as GPS coordinates of the positioning unit to the microprocessor for analysis and processing while the intrusion sensor detects an intrusion; then a digital signal is transmitted to a signal receiving module in the mainframe by the signal transmitting module;
wherein the mainframe is mounted with a processor, the signal receiving module, an information display module and a central data center therein; the signal receiving module in the mainframe is electrically connected to the signal transmitting modules in the positioning units while the information display module in the mainframe is in electrical connection with the mobile device through the processor; a sensor signal is transmitted from the signal transmitting module in the positioning unit to the signal receiving module of the mainframe and shown on the mobile device and the information display module of the mainframe when the intrusion sensor in the positioning unit is activated;
the done is able to be operated manually to execute protection actions such as monitoring and deterring quickly by using a command line interface on the information display module of the mainframe or a mobile device application (APP) with a command line interface; or protective measures are executed automatically by commands for monitoring, deterring or catching purposes preset in the processor of the mainframe or the mobile device APP.

3. In the present invention, the drone is disposed with a deterrent device that is selected from a CCD camera, a strong light beam, an ultrasonic frequency, a high audio frequency, a net ejector or a voice amplifier microphone for taking pictures and videos and deterring the intruder; the drone immediately flies to the GPS coordinates of the intrusion location when the processor of the mainframe informs the drone and the mobile device according to preset protection command; an infrared (IR) temperature sensor disposed thereon is activated once the drone reaches the intrusion location for finding out what the intruder is according to different temperatures of human body or animal measured; temperature data obtained is transmitted to the mainframe wirelessly and the processor in the mainframe sends a command to the drone for locking the intruder out according to the temperature data and keeping monitoring and deterring the intruder;
wherein the drone activates the CCD right away for taking pictures and one-to-one monitoring of the intruder; a plurality of drones is activated to monitor each of the intruders respectively according to a plurality of intrusion locations; the images or videos of the intruder monitored and captured by the CCD on the drone are transmitted to the mainframe and the mobile device synchronously for storage; the CCD is able to be an infrared night-vision camera that works well at night;
wherein the CCD transmits the images captured to the mainframe and the mobile device synchronously so that the processor and the central data center perform data analysis of the intruder to confirm that the intruder is a person, an animal or a movable machine; then the processor of the mainframe or the APP interface on the mobile device determines whether a deterrent action is taken; once it is confirmed that the deterrent action is taken, a device arranged at the drone such as a strong light beam, an ultrasonic frequency, a high audio frequency, or a voice amplifier microphone is turned on by manual operation, automatic computer control of the mainframe, or manual operation of the mobile device to warn or talk to the intruder, thus the intruder is deterred and driven away-, the strong light beam is aimed onto the intruder while the ultrasonic frequency and the high audio frequency are used for interfering and deterring respectively; the voice amplifier microphone is used to warn and talk to the intruder; or a net ejector equipped on the drone is activated to catch the intruder; wherein the drone is able to be equipped with an offensive weapon for attacking the intruder.

4. The wireless charger module disposed on the motion sensored security drone applied to the security system is used for providing power to the at least one drone wirelessly all the times; but the charge mode of the drone is not limited to this way.
